(19) United States
(12) Patent Application Publication
(10) Pub. No.: US 2020/0302010 A1
(43) Pub. Date: Sep. 24, 2020

(54) INFORMATION PROCESSING SYSTEM AND NON-TRANSITORY COMPUTER READABLE MEDIUM STORING PROGRAM

(71) Applicant: FUJI XEROX CO., LTD., Tokyo (JP)

(72) Inventors: Fumiyoshi KAWASE, Kanagawa (JP); Takashi SAKAMOTO, Kanagawa (JP); Katsuma NAKAMOTO, Kanagawa (JP)

(73) Assignee: FUJI XEROX CO., LTD., Tokyo (JP)

(21) Appl. No.: 16/521,559

(22) Filed: Jul. 24, 2019

(30) Foreign Application Priority Data
Mar. 19, 2019 (JP) 2019-051039

(51) Int. Cl. G06F 17/24; G06F 17/21

(52) U.S. Cl. CPC G06F 17/248; G06F 17/212

(57) ABSTRACT

An information processing system includes an acquisition section that acquires image data and an editing section that, in a case where a form determined to emphasize specific information in image data is prepared in advance and information included in the acquired image data satisfies a predetermined condition, edits the image data so as to emphasize the specific information in the image data in accordance with the form.

### CROSS-REFERENCE TO RELATED APPLICATIONS

This application is based on and claims priority under 35 USC 119 from Japanese Patent Application No. 2019-051039 filed Mar. 19, 2019.

### BACKGROUND

### (i) Technical Field

The present invention relates to an information processing system and a non-transitory computer readable medium storing a program.

### (ii) Related Art

For example, JP2006-238289A discloses a display data scaling method in which image data is separated into a text region and a background other than the text region, by text/background separation or layout analysis processing being performed on the graphic represented by the image data, as the image represented by the graphic information is displayed on a two-dimensional display surface, the size of one text is measured by OCR processing or text rectangle analysis processing being performed in the text region, a display magnification is automatically calculated from the text size, and at least one of the two-dimensional directions on the two-dimensional display surface of the image represented by the image data is scaling-processed at the display magnification.

### SUMMARY

In some cases, for example, image data such as image data obtained by image reading means for reading an image formed on a manuscript is displayed.

However, once the image data is displayed as it is, for example, the text and the image in the image data may be displayed small and it may be difficult for an operator to grasp specific information in the image data.

Aspects of non-limiting embodiments of the present disclosure relate to an information processing system and a non-transitory computer readable medium storing a program making it easier for an operator to grasp specific information in image data than in the case of a configuration in which image data is displayed as it is.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

An information processing system includes an acquisition section that acquires image data and an editing section that, in a case where a form determined to emphasize specific information in image data is prepared in advance and information included in the acquired image data satisfies a predetermined condition, edits the image data so as to emphasize the specific information in the image data in accordance with the form.

### BRIEF DESCRIPTION OF THE DRAWINGS

Exemplary embodiment(s) of the present invention will be described in detail based on the following figures, wherein:

FIG. 1 is a diagram illustrating an overall configuration example of an image display system according to the present exemplary embodiment;

FIG. 2 is a diagram illustrating a hardware configuration example of a display control device according to the present exemplary embodiment;

FIG. 3 is a block diagram illustrating a functional configuration example of the display control device according to the present exemplary embodiment;

FIG. 4 is a flowchart illustrating an example of an image data editing processing procedure;

FIGS. 5A to 5D are diagrams illustrating an example of templates stored in a template storage unit;

FIG. 6 is a diagram illustrating an example of the template stored in the template storage unit;

FIGS. 7A to 7D are diagrams illustrating an example of the templates stored in the template storage unit;

FIGS. 8A to 8C are diagrams illustrating an example of the templates stored in the template storage unit;

FIG. 9 is a diagram illustrating an example of association information stored in the template storage unit;

FIGS. 10A to 10C are diagrams illustrating a specific example of image data editing processing;

FIGS. 11A to 11C are diagrams illustrating a specific example of the image data editing processing; and

FIGS. 12A to 12C are diagrams illustrating a specific example of the image data editing processing.

### DETAILED DESCRIPTION

Hereinafter, an exemplary embodiment of the present invention will be described in detail with reference to accompanying drawings.

<Overall Configuration of Image Display System>

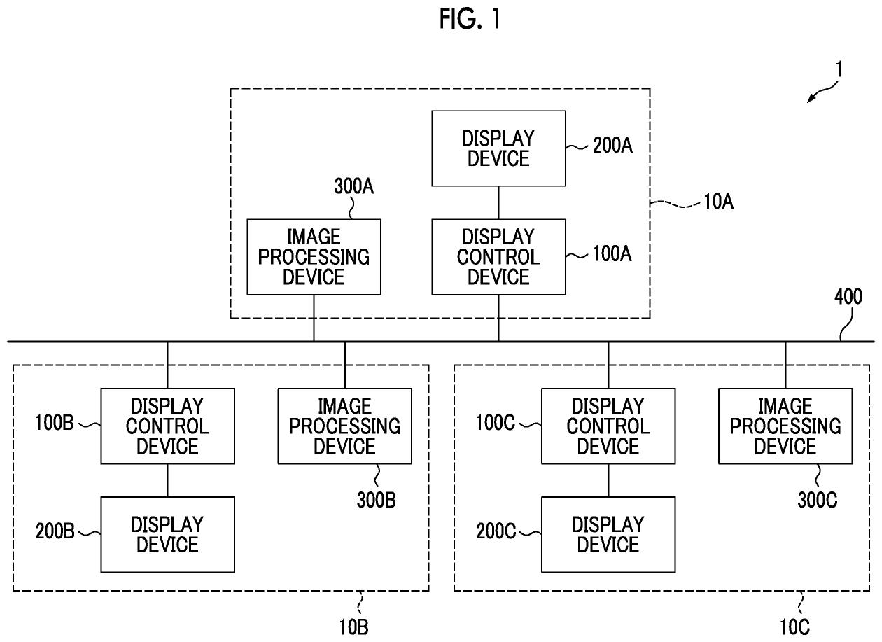

FIG. 1 is a diagram illustrating an overall configuration example of an image display system 1 according to the present exemplary embodiment.

As illustrated in the drawing, the image display system 1 is provided with basic systems 10A to 10C.

The basic system 10A is provided with a display control device 100A, a display device 200A, and an image processing device 300A.

Likewise, the basic system 10B is provided with a display control device 100B, a display device 200B, and an image processing device 300B.

The basic system 10C is provided with a display control device 100C, a display device 200C, and an image processing device 300C.

Each of the basic systems 10A to 10C is connected to a network 400.

In the example illustrated in FIG. 1, each of the display control devices 100A to 100C and the image processing devices 300A to 300C is connected to the network 400.

The display devices 200A to 200C are connected to the display control devices 100A to 100C, respectively.

Although the basic systems 10A to 10C are illustrated in FIG. 1, the basic systems 10A to 10C may be referred to as a basic system 10 in a case where it is unnecessary to distinguish the basic systems 10A to 10C.

Although the display control devices 100A to 100C are illustrated in FIG. 1, the display control devices 100A to 100C may be referred to as a display control device 100 in a case where it is unnecessary to distinguish the display control devices 100A to 100C.

Although the display devices 200A to 200C are illustrated in FIG. 1, the display devices 200A to 200C may be referred to as a display device 200 in a case where it is unnecessary to distinguish the display devices 200A to 200C.

Although the image processing devices 300A to 300C are illustrated in FIG. 1, the image processing devices 300A to 300C may be referred to as an image processing device 300 in a case where it is unnecessary to distinguish the image processing devices 300A to 300C.

Although three basic systems 10 are illustrated in the example illustrated in FIG. 1, the basic system 10 is not limited to three in number.

Although one display device 200 is illustrated in the basic system 10, two or more display devices 200 may be provided in the basic system 10.

In the present exemplary embodiment, the image display system 1, the basic system 10, and the display control device 100 are used as an example of an information processing system.

The display device 200 is used as an example of a display section.

The display control device 100 is a computer device controlling the display of a display unit such as a display of the display device 200.

For example, the display control device 100A controls the display of the display device 200A provided in the basic system 10A.

Although details will be described later, the display control device 100 edits image data so as to emphasize specific information in the image data in displaying the image data on the display device 200.

Then, the display control device 100 performs control such that the edited image data is displayed on the display device 200.

A controller of digital signage such as a personal computer (PC) is exemplified as the display control device 100.

The display device 200 has the display unit such as the display and displays the image data received from the display control device 100.

The display device 200 is installed at, for example, a place where people gather or a place where gathering of people is desired.

More specifically, the display device 200 is installed at a store such as a retail store, a public facility such as a library and a government office, an office, and the like.

By the image data being displayed on the display device 200, a person around the display device 200 or the like is notified of the information included in the image data.

The image processing device 300 has an image processing function such as a print function, a scan function, a copy function, and a facsimile function and executes image processing.

Here, the image processing device 300 has image reading means (not illustrated) executing a scan function and image data is generated by the image reading means reading an image formed on a manuscript.

The network 400 is communication means used for information communication between devices such as the display control device 100 and the image processing device 300. The network 400 is, for example, the Internet, a public line, or a local area network (LAN).

In a case where image data is displayed on the display device 200A, for example, an operator sets a manuscript on the image processing device 300A and executes the scan function.

By means of the scan function, the image reading means of the image processing device 300A reads an image formed on the manuscript and generates the image data.

Then, the image processing device 300A transmits the generated image data to the display control device 100A.

Once the display control device 100A acquires the image data, the display control device 100A edits the acquired image data and performs control such that the edited image data is displayed on the display device 200A.

The operator may execute the scan function after setting a plurality of manuscripts.

In this case, the image processing device 300A sequentially transmits image data to the display control device 100A.

The display control device 100A edits the image data sent from the image processing device 300A and performs control such that the edited image data are displayed in order on the display device 200A.

In the image display system 1, information in the same image data may be displayed on the plurality of display devices 200 by means of the mutual cooperation of the basic systems 10.

For example, in executing the scan function with the image processing device 300A, an operator designates the display control device 100B and the display control device 100C as well as the display control device 100A as image data transmission destinations.

In this case, the image processing device 300A transmits generated image data to the display control devices 100A to 100C.

Then, each of the display control devices 100A to 100C edits the received image data and performs control such that the edited image data is displayed on the display devices 200A to 200C.

Here, the display control device 100 may transmit the image data to the other display control devices 100 instead of the image processing device 300 transmitting the image data to the plurality of display control devices 100.

In the present exemplary embodiment, the image data displayed on the display device 200 by the display control device 100 is not limited to the image data obtained by the image reading means of the image processing device 300. Any image data may be displayed on the display device 200.

For example, the display control device 100 may display image data such as a document file created by the display control device 100 or another device on the display device 200.

<Hardware Configuration of Display Control Device>

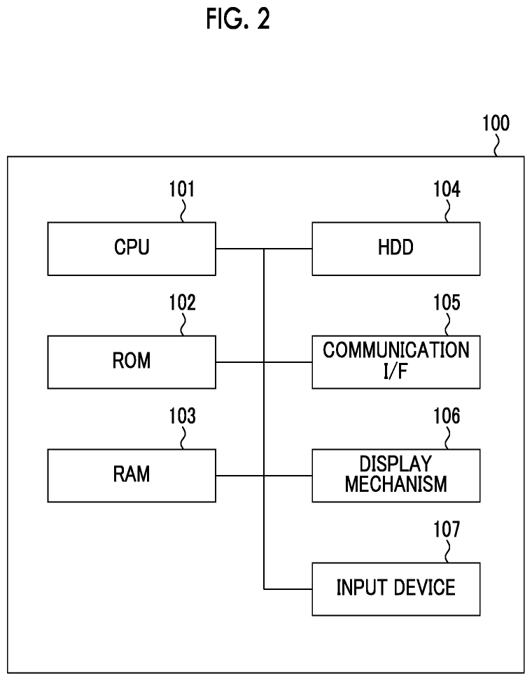

FIG. 2 is a diagram illustrating a hardware configuration example of the display control device 100 according to the present exemplary embodiment.

As illustrated in the drawing, the display control device 100 is provided with a central processing unit (CPU) 101 as calculation means, a read only memory (ROM) 102 as a storage region where a program such as a basic input output system (BIOS) is stored, a random access memory (RAM) 103 as an execution region where the program is executed, and a hard disk drive (HDD) 104 as a storage region where various non-transitory computer readable media storing programs such as operating systems (OSs) and applications, input data with respect to the various non-transitory computer readable media storing programs, output data from the various non-transitory computer readable media storing programs, and the like are stored.

The program stored in the ROM 102, the HDD 104, or the like is read by the RAM 103 and executed by the CPU 101.

As a result, the function of the display control device 100 is realized.

Further, the display control device 100 is provided with a communication interface (communication I/F) 105 for communicating with the outside, a display mechanism 106 such as a display, and an input device 107 such as a keyboard, a mouse, and a touch panel.

<Functional Configuration of Display Control Device>

Next, the functional configuration of the display control device 100 according to the present exemplary embodiment will be described.

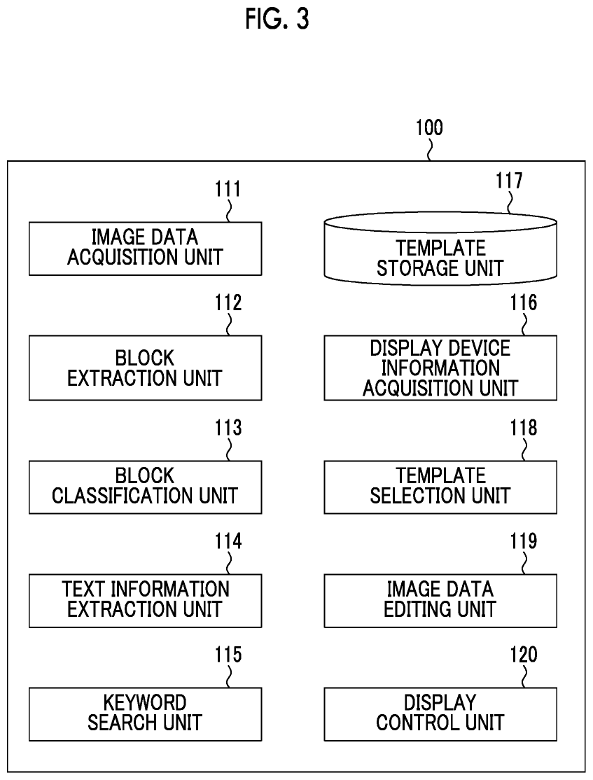

FIG. 3 is a block diagram illustrating a functional configuration example of the display control device 100 according to the present exemplary embodiment.

The display control device 100 according to the present exemplary embodiment is provided with an image data acquisition unit 111, a block extraction unit 112, a block classification unit 113, a text information extraction unit 114, a keyword search unit 115, a display device information acquisition unit 116, a template storage unit 117, a template selection unit 118, an image data editing unit 119, and a display control unit 120.

The image data acquisition unit 111 as an example of an acquisition section acquires image data to be displayed on the display device 200.

For example, the image data acquisition unit 111 acquires the image data acquired by the image reading means of the image processing device 300.

In addition, for example, the image data acquisition unit 111 acquires the image data of a document file created by the display control device 100 or another device.

The block extraction unit 112 extracts one or more blocks in the image data acquired by the image data acquisition unit 111.

The block indicates a block of information included in the image data.

For example, a rectangular region is extracted as the block. The shape of the block may be a triangular shape or a circular shape and is not limited to a rectangular shape.

The block extraction unit 112 extracts one block in a case where only one block can be extracted from the image data. The block extraction unit 112 extracts a plurality of blocks insofar as the plurality of blocks can be extracted.

More specifically, the block extraction unit 112 grasps the feature of the information included in the image data by using a conventional method such as image analysis, color analysis, edge detection, optical character recognition (OCR), and text-image separation.

Then, the block is extracted based on the grasped feature.

The block to be extracted is a text block as a text-described region, an image block as an image-disposed region, or the like.

The OCR is a technique for analyzing a text on image data and converting the text into text data handled by a computer.

The block classification unit 113 performs classification with regard to every block extracted by the block extraction unit 112.

Then, the block classification unit 113 associates a classification type with each extracted block.

More specifically, the block classification unit 113 collects the feature of each block by using, for example, a method similar to the block extraction.

Then, the block classification unit 113 performs block classification in accordance with the collected features.

For example, the block classification unit 113 performs classification as the text blocks or classification as the image blocks depending on the collected features of the blocks.

The image blocks are classified into types such as a map image, a landscape image, a person image, and a photograph.

In a case where the map image, the landscape image, and the person image are photographs, the images may be classified as photographs.

To be more specific, the blocks are classified in accordance with predetermined criteria.

For example, the block is classified as the text block in a case where a feature quantity such as the color, the brightness, the outline, and the shape of the information included in the block satisfies a certain condition.

The block is classified as the image block in a case where the feature quantity of the information included in the block does not satisfy the certain condition (or in a case where another condition is satisfied).

The image blocks are further classified into, for example, a map image, a landscape image, a person image, and a photograph based on the feature quantities.

For example, classification as the text block is performed in a case where at least one text is included in the block.

In another example, classification as the text block may be performed in a case where the number of texts in the block is equal to or greater than a threshold and classification as the image block may be performed in a case where the number of texts in the block falls short of the threshold.

The text information extraction unit 114 extracts text information with regard to the block classified as the text block by the block classification unit 113.

Then, the text information extraction unit 114 associates the extracted text information with the text block.

More specifically, for example, the text information extraction unit 114 extracts the text information included in the text block by performing OCR processing on the text block.

The keyword search unit 115 searches for a predetermined keyword (hereinafter, simply referred to as “keyword”) with regard to the text block.

Here, the keyword search unit 115 determines, for each text block, whether or not the keyword is included in the text information in the text block.

Then, the keyword search unit 115 associates the keyword with the text block including the keyword.

The keyword is a character string such as conference, holding, guide, advertisement, and sale. The keyword is predetermined as text information to be emphasized.

In the present exemplary embodiment, the keyword is used as an example of a specific character string.

The display device information acquisition unit 116 acquires information on the display device 200 from the display device 200.

The information on the display device 200 includes, for example, non-screen information such as the processing speed of the display device 200 as well as information on a screen such as the size of the screen, the shape of the screen, and the maximum resolution of the screen.

The size of the screen is, for example, 100 inches and 1,771 mm□996 mm.

The shape of the screen is, for example, rectangular or circular.

In a case where the screen is rectangular, information may be acquired such as “vertical type” as a shape in which the vertical length exceeds the horizontal length and “horizontal type” as a shape in which the horizontal length exceeds the vertical length.

In the case of presence of the plurality of image data-displaying display devices 200, the display device information acquisition unit 116 acquires information on the plurality of display devices 200.

The information on the display device 200 is not limited to the configuration of acquisition from the display device 200.

For example, the information on the display device 200 may be pre-stored in the display control device 100.

The template storage unit 117 stores a template used for image data editing.

This template is a template determined so as to emphasize specific information in image data.

For example, a template determined so as to emphasize a specific type of image block and a template determined so as to emphasize the text block including the keyword are prepared in advance.

Also stored in the template storage unit 117 is information (hereinafter, referred to as “association information”) indicating the association between the template and a condition for template application (hereinafter, referred to as “template application condition”).

The template application condition is a condition determined with regard to the information included in the image data and the information on the display device 200.

The information included in the image data is information on the type associated with each block by the block classification unit 113 or information on the keyword associated with each block by the keyword search unit 115.

The information on the display device 200 is acquired by the display device information acquisition unit 116.

In the present exemplary embodiment, the template is used as an example of a form determined so as to emphasize the specific information in the image data.

In addition, the template application condition is used as an example of a predetermined condition.

The template selection unit 118 selects a template to be applied to the image data from the templates stored in the template storage unit 117.

Here, the template selection unit 118 refers to the association information stored in the template storage unit 117.

Then, the template to be applied to the image data is selected based on the information on the type associated with each block by the block classification unit 113, the information on the keyword associated with each block by the keyword search unit 115, the information on the display device 200 acquired by the display device information acquisition unit 116, or the like.

The image data editing unit 119 as an example of an editing section applies the template selected by the template selection unit 118 to the image data.

Then, the image data editing unit 119 edits the image data so as to emphasize the specific information in the image data in accordance with the template.

The display control unit 120 outputs the edited image data to the display device 200 and controls the display of the display device 200.

The display device 200 displays the edited image data by the edited image data being transmitted from the display control unit 120.

Each functional unit constituting the display control device 100 is realized by software and hardware resources cooperating with each other.

Specifically, in a case where the display control device 100 is realized by means of the hardware configuration illustrated in FIG. 2, for example, the various non-transitory computer readable media storing programs stored in the ROM 102, the HDD 104, or the like are read by the RAM 103 and executed by the CPU 101, and then the functional units such as the image data acquisition unit 111, the block extraction unit 112, the block classification unit 113, the text information extraction unit 114, the keyword search unit 115, the display device information acquisition unit 116, the template selection unit 118, the image data editing unit 119, and the display control unit 120 illustrated in FIG. 3 are realized.

The template storage unit 117 is realized by, for example, the HDD 104.

<Processing Procedure for Image Data Editing>

Next, a procedure for image data editing processing will be described.

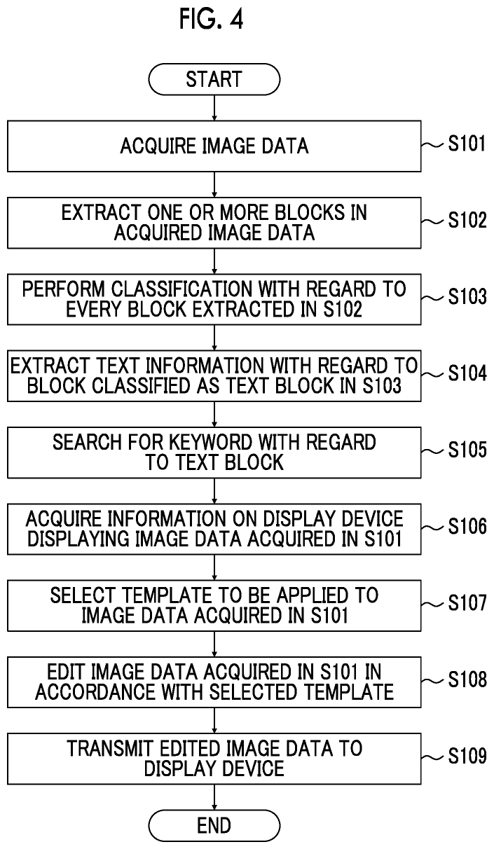

FIG. 4 is a flowchart illustrating an example of the image data editing processing procedure.

In the following description, symbol “S” indicates processing steps in some cases.

First, scan processing is executed with the image processing device 300 by, for example, an operator performing an operation for executing the scan processing with the image processing device 300.

Then, the image data generated by the image reading means of the image processing device 300 is transmitted to the display control device 100 and the image data acquisition unit 111 acquires the image data (S101).

Next, the block extraction unit 112 extracts one or more blocks in the acquired image data (S102).

Next, the block classification unit 113 performs classification with regard to every block extracted in S102 (S103).

Next, the text information extraction unit 114 extracts text information with regard to the block classified as the text block in S103 (S104).

Next, the keyword search unit 115 searches for the keyword with regard to the text block (S105).

Next, the display device information acquisition unit 116 acquires information on the display device 200 displaying the image data acquired in S101 (S106).

Here, the display device information acquisition unit 116 acquires information such as the size and the shape of the screen of the display device 200.

Next, the template selection unit 118 selects a template to be applied to the image data acquired in S101 (S107).

Here, the template selection unit 118 refers to the association information stored in the template storage unit 117 and selects the template to be applied to the image data based on the information on the type associated with each block in S103, the information on the keyword associated with each text block in S105, the information on the display device 200 acquired in S106, or the like.

Next, the image data editing unit 119 edits the image data acquired in S101 in accordance with the selected template (S108).

Next, the display control unit 120 transmits the edited image data to the display device 200 (S109).

By the edited image data being transmitted, the edited image data is displayed on the display device 200.

Then, this processing flow ends.

<Description of Template>

Next, the template stored in the template storage unit 117 will be described based on a specific example.

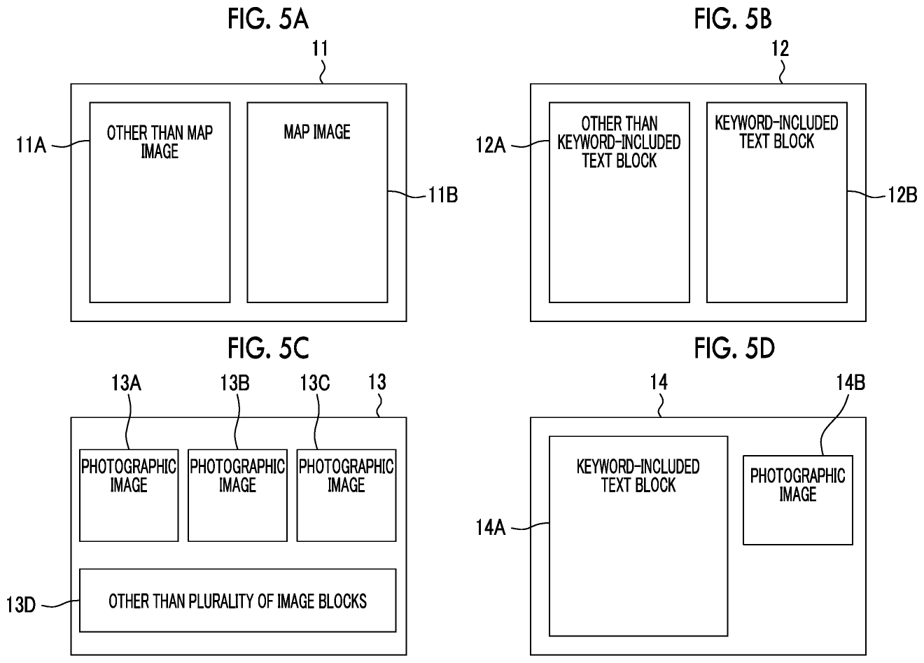

FIGS. 5 to 8 are diagrams illustrating an example of the template stored in the template storage unit 117.

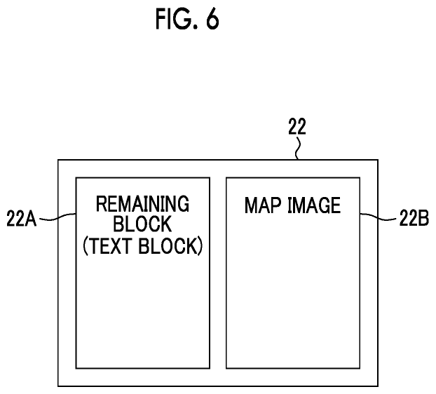

The example illustrated in FIGS. 5 and 6 is an example of the template applied in a case where the display device 200 has a “standard” screen size and the screen is horizontal.

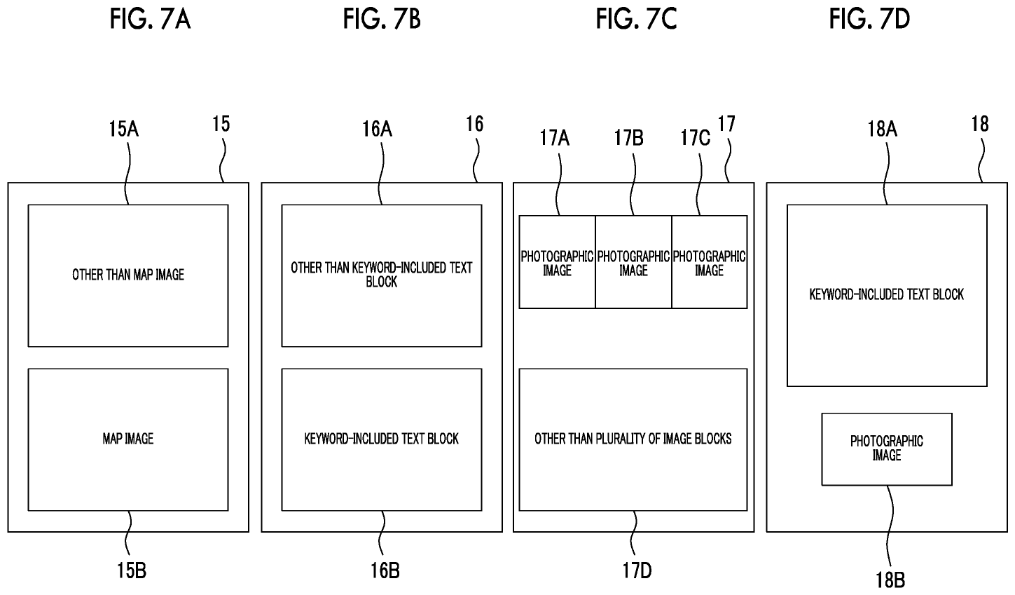

The example illustrated in FIG. 7 is an example of the template applied in a case where the display device 200 has a “standard” screen size and the screen is vertical.

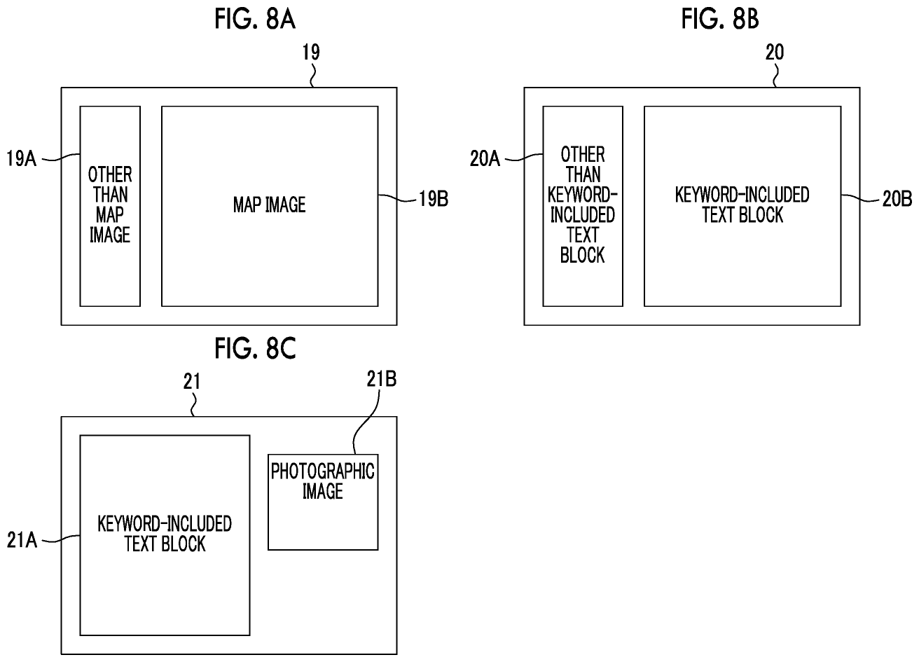

The example illustrated in FIG. 8 is an example of the template applied in a case where the display device 200 has a “small” screen size and the screen is horizontal.

A template 11 illustrated in FIG. 5A is applied in a case where one map image is in the image data.

The map image is emphasized by this template being applied.

Specifically, the map image is enlarged and disposed on the right side of the image data.

In addition, blocks other than the map image are disposed on the left side of the image data.

To be more specific, in the template 11, a region 11A is determined as the region where the blocks other than the map image are disposed.

In addition, a region 11B is determined as the region where the map image is disposed.

The regions 11A and 11B indicate the size and the position of disposition of each block in the image data.

For example, the size of the region 11A is 40% of the entire template 11.

Likewise, the size of the region 11B is 40% of the entire template 11.

Accordingly, once the template 11 is applied to the image data, the map image of the image data is enlarged and disposed so as to reach 40% of the image data in size in accordance with the region 11B.

In addition, the blocks other than the map image (that is, image or text blocks other than the map image) are collected and disposed so as to fit within 40% of the image data in size in accordance with the region 11A.

At that time, the image or text blocks may be enlarged or reduced.

A template 12 illustrated in FIG. 5B is applied in a case where one keyword-included text block is in the image data.

The keyword-included text block is emphasized by this template being applied.

Specifically, the keyword-included text block is enlarged and disposed on the right side of the image data.

In addition, blocks other than the keyword-included text block are disposed on the left side of the image data.

To be more specific, in the template 12, a region 12A is determined as the region where the blocks other than the keyword-included text block are disposed.

In addition, a region 12B is determined as the region where the keyword-included text block is disposed.

A template 13 illustrated in FIG. 5C is applied in the case of presence of a plurality of image blocks of the same type in the image data.

Although three photographic blocks are illustrated as an example of the plurality of image blocks of the same type in the example illustrated in FIG. 5C, the type of the image blocks is not limited to a photographic image.

In addition, the image blocks are not limited to three in number.

Once this template is applied, the image blocks are disposed side by side in a lateral direction.

In addition, blocks other than the plurality of image blocks are disposed below the plurality of image blocks.

To be more specific, in this example, regions 13A to 13C are determined as the regions where three photographic images are disposed.

A region 13D is determined as the region where blocks other than the three photographic images are disposed.

When the three photographic images are disposed, the three photographic images are enlarged or reduced in accordance with the regions 13A to 13C.

The individual photographic images are emphasized by the three photographic images being disposed side by side or enlarged.

A template 14 illustrated in FIG. 5D is applied in a case where one photographic image and one keyword-included text block are in the image data.

The keyword-included text block is emphasized once this template is applied.

Specifically, the keyword-included text block is enlarged and disposed on the left side of the image data.

In addition, the photographic image is disposed on the right side of the image data.

To be more specific, in the template 14, a region 14A is determined as the region where the text block is disposed.

In addition, a region 14B is determined as the region where the photographic image is disposed.

A template 22 illustrated in FIG. 6 is applied in a case where one map image and one or more image blocks other than the map image are in the image data.

The map image is emphasized once this template is applied.

In addition, the image blocks other than the map image are deleted.

Specifically, the map image is enlarged and disposed on the right side of the image data.

In addition, the image blocks other than the map image are deleted and are not disposed in the edited image data.

Further, text blocks are disposed on the left side of the image data as the remaining blocks.

To be more specific, in the template 22, a region 22A is determined as the region where the text blocks are disposed.

In addition, a region 22B is determined as the region where the map image is disposed.

A template in which partial information included in the image data is determined to be deleted may be prepared as the template in this manner.

Next, a template 15 illustrated in FIG. 7A is applied in a case where one map image is in the image data as in FIG. 5A.

The map image is emphasized once this template is applied.

Specifically, the map image is enlarged and disposed on the lower side of the image data.

In addition, blocks other than the map image are disposed on the upper side of the image data.

To be more specific, in the template 15, a region 15A is determined as the region where the blocks other than the map image are disposed.

In addition, a region 15B is determined as the region where the map image is disposed.

A template 16 illustrated in FIG. 7B is applied in a case where one keyword-included text block is in the image data as in FIG. 5B.

The keyword-included text block is emphasized once this template is applied.

Specifically, the keyword-included text block is enlarged and disposed on the lower side of the image data.

In addition, blocks other than the keyword-included text block are disposed on the upper side of the image data.

To be more specific, in the template 16, a region 16A is determined as the region where the blocks other than the keyword-included text block are disposed.

In addition, a region 16B is determined as the region where the keyword-included text block is disposed.

A template 17 illustrated in FIG. 7C is applied in the case of presence of a plurality of image blocks of the same type in the image data as in FIG. 5C.

The image blocks are disposed side by side in the lateral direction once this template is applied.

In addition, blocks other than the image blocks are disposed below the image blocks.

In the example illustrated in FIG. 7C, three photographic blocks are illustrated as an example of the plurality of image blocks of the same type.

To be more specific, in the template 17, regions 17A to 17C are determined as the regions where the three photographic images are disposed.

In addition, a region 17D is determined as the region where the blocks other than the three photographic images are disposed.

A template 18 illustrated in FIG. 7D is applied in a case where one photographic image and one keyword-included text block are in the image data as in FIG. 5D.

The keyword-included text block is emphasized once this template is applied.

Specifically, the keyword-included text block is enlarged and disposed on the upper side of the image data.

In addition, the photographic image is disposed on the lower side of the image data.

To be more specific, in the template 18, a region 18A is determined as the region where the text block is disposed.

In addition, a region 18B is determined as the region where the photographic image is disposed.

Next, a template 19 illustrated in FIG. 8A is applied in a case where one map image is in the image data as in FIG. 5A.

The map image is emphasized once this template is applied.

Specifically, the map image is enlarged and disposed on the right side of the image data.

In addition, blocks other than the map image are disposed on the left side of the image data.

To be more specific, in the template 19, a region 19A is determined as the region where the blocks other than the map image are disposed.

In addition, a region 19B is determined as the region where the map image is disposed.

The template 19 is applied in a case where the size of the screen is “small”.

Accordingly, the size of the displayed image data is smaller as a whole than in a case where the size of the screen is “standard”.

Accordingly, the map image is further emphasized as compared with, for example, the template 11 (see FIG. 5A) applied in a case where the size of the screen is “standard”.

More specifically, 80% of the screen is the region of the map image in the template 19 whereas, for example, 40% of the screen is the region of the map image in the template 11.

A template 20 illustrated in FIG. 8B is applied in a case where one keyword-included text block is in the image data as in FIG. 5B.

The keyword-included text block is emphasized once this template is applied.

Specifically, the keyword-included text block is enlarged and disposed on the right side of the image data.

In addition, blocks other than the keyword-included text block are disposed on the left side of the image data.

To be more specific, in the template 20, a region 20A is determined as the region where the blocks other than the keyword-included text block are disposed.

In addition, a region 20B is determined as the region where the keyword-included text block is disposed.

The template 20 is applied in a case where the size of the screen is “small”. The keyword-included text block is further emphasized as compared with, for example, the template 12 (see FIG. 5B) applied in a case where the size of the screen is “standard”.

More specifically, 80% of the screen is the region of the keyword-included text block in the template 20 whereas, for example, 40% of the screen is the region of the keyword-included text block in the template 12.

As another method for emphasizing the keyword-included text block, for example, the keyword-included surrounding region may be extracted and only the extracted region may be enlarged instead of the entire text being enlarged with regard to the keyword-included text block.

For example, it is assumed that the text block includes 1,000 texts and the keyword-included surrounding region includes 200 texts.

Once the template 20 is applied in this case, the 200 texts included in the extracted region are enlarged without the remaining 800 texts being enlarged.

The remaining 800 texts may be reduced or enlarged at an enlargement rate smaller than the enlargement rate of the extracted 200 texts.

In addition, the remaining 800 texts may be deleted.

Further, as another method for emphasizing the keyword-included text block, for example, the color of the 200 texts included in the keyword-included surrounding region may be changed or highlight display such as reverse display may be performed.

A template 21 illustrated in FIG. 8C is applied in a case where one photographic image and one keyword-included text block are in the image data as in FIG. 5D.

The keyword-included text block is emphasized once this template is applied.

Specifically, the keyword-included text block is enlarged and disposed on the left side of the image data.

In addition, the photographic image is disposed on the right side of the image data.

To be more specific, in the template 21, a region 21A is determined as the region where the text block is disposed.

In addition, a region 21B is determined as the region where the photographic image is disposed.

The template 21 is applied in a case where the size of the screen is “small”. The keyword-included text block is further emphasized as compared with, for example, the template 14 (see FIG. 5D) applied in a case where the size of the screen is “standard”.

A method similar to the method pertaining to the template 20 is used as a method for emphasizing the keyword-included text block.

The specific information may be emphasized by highlight display or enlargement of the keyword-included surrounding region even in the template applied in a case where the screen has a size other than “small” as in the case of the template (see FIG. 5B).

Although only map images and photographic images are defined as image blocks in the templates illustrated in FIGS. 5 to 8, the present invention is not limited to the configuration.

For example, a template in which image blocks such as a landscape image and a person image are defined may be prepared and the images may be emphasized.

Further, although the character string of the keyword included in the text block is not specified in detail in the templates illustrated in FIGS. 5 to 8, the present invention is not limited to the configuration.

For example, a template in which text blocks including a specific character string such as conference, holding, and guide are defined may be prepared and the text blocks may be emphasized.

In addition, the keyword may be changed for each template.

For example, the template 12 illustrated in FIG. 5B is applied in a case where one text block including the keyword of “holding” or “sale” is in the image data.

The template 14 illustrated in FIG. 5D is applied in a case where one photographic image and one text block including the keyword of “conference” are in the image data.

In the present exemplary embodiment, the keyword-included text block is used as an example of text information satisfying a specific condition.

In addition, a specific type of image block such as the map image, the plurality of image blocks of the same type, and the like are used as an example of image information satisfying a specific condition.

<Description of Association Information>

Next, the association information stored in the template storage unit 117 will be described based on a specific example.

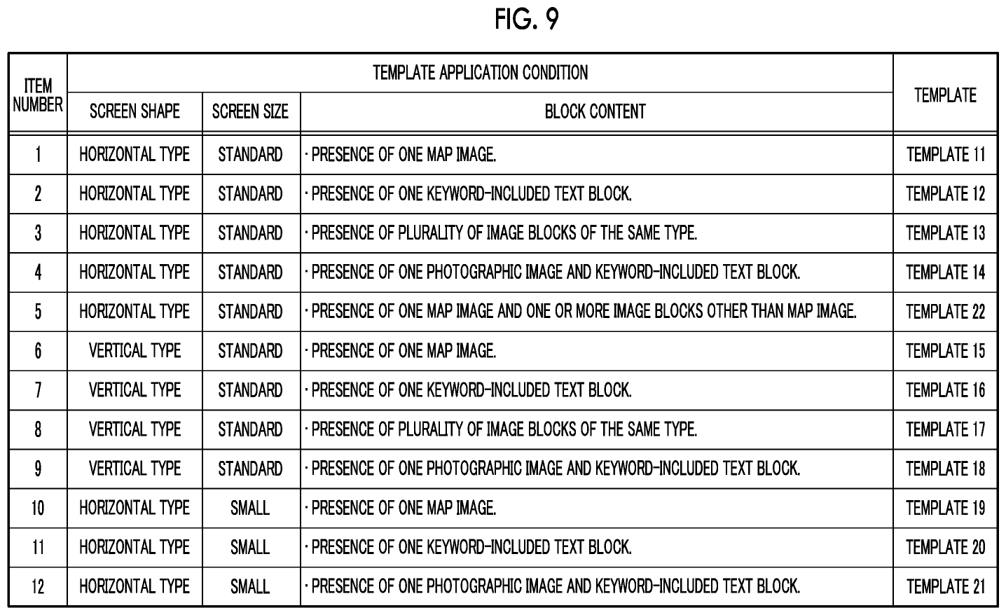

FIG. 9 is a diagram illustrating an example of the association information stored in the template storage unit 117.

The template and the template application condition are associated with each other in the association information.

In this example, 12 template application conditions are present with the item numbers of “1” to “12” and the template is prepared for each template application condition.

More specifically, the template application conditions include the items of “screen shape”, “screen size”, and “block content”.

“Screen shape” and “screen size” are conditions determined with regard to the information on the display device 200.

“Block content” is a condition determined with regard to the information included in the image data.

For example, the template application condition and the template 11 (see FIG. 5A) are associated with each other in item number “1”.

Determined here as the template application condition is the condition that “screen shape” is “horizontal”, “screen size” is “standard”, and “block content” is “presence of one map image”.

Specifically, the condition is that the shape of the screen of the display device 200 is horizontal and the size of the screen is “standard”.

In addition, the condition is that one map image is in the image data.

In a case where these conditions are satisfied, the template 11 is selected as the template applied to the image data.

Predetermined in the association information are, for example, screen size conditions such as “small” for less than 10 inches, “standard” for 10 inches or more and less than 50 inches, and “large” for 50 inches or more.

However, the display control device 100 may acquire the sizes of the screens of the plurality of display devices 200 present in the image display system 1, compare the respective screen sizes, and determine the conditions such as “small”, “standard”, and “large”.

For example, the screen of the display device 200A is “large”, the screen of the display device 200B is “standard”, and the screen of the display device 200C is “small” in a case where image data are displayed on the display devices 200A to 200C, the screen of the display device 200A is the largest, and the screen of the display device 200C is the smallest.

<Processing in Case where Plurality of Candidate Templates are Present to be Applied to Image Data>

A plurality of candidate templates are present to be applied to the image data in a case where the information included in the image data or the like satisfies a plurality of template application conditions.

In this case, the template selection unit 118 selects anyone template from the plurality of candidates in accordance with predetermined criteria.

For example, priority setting is performed in advance for each type of information included in the image data.

More specifically, the priority setting is performed with respect to the types of the blocks and the information included in the blocks.

In this case, the template selection unit 118 preferentially selects a template determined so as to emphasize high-priority information from the plurality of candidates.

For example, the map image, the photographic image, the keyword (conference), the keyword (holding), the keyword (advertisement), another keyword, and another image block are determined in descending order of priority.

Here, it is assumed that the text blocks including the map image, the photographic image, and the keyword (conference) are present in the image data.

In this case, for example, the templates 11, 12, 14, and 22 are selected as the candidate templates to be applied to the image data referring to the template application condition of the association information in FIG. 9.

Then, the template selection unit 118 selects the template determined so as to emphasize the map image with the highest priority.

Specifically, the templates 11 and 22 are selected.

For example, it is determined in advance that the template 11 is preferentially selected although either the template 11 or the template 22 may be selected.

The template itself may be prioritized in advance as well.

For example, in the case of presence of a plurality of candidate templates to be applied to the image data, the template selection unit 118 selects the template with the highest priority from the plurality of candidates in accordance with a predetermined order of priority.

The priority set for each type of information included in the image data and the priority set for the template itself may vary with the place of installation of the display device 200 (that is, the place where the image data is displayed).

For example, the priority for each type of information included in the image data is set such that the map image has the highest priority in a case where the display device 200 is installed at a retail store.

In addition, the priority of the template itself is set such that, for example, the template 11 is given the highest priority in the association information illustrated in FIG. 9.

In a case where the display device 200 is installed at an office, for example, the priority for each type of information included in the image data is set such that the text block including the keyword (conference) is given the highest priority.

In addition, the priority of the template itself is set such that, for example, the template 12 is given the highest priority in the association information illustrated in FIG. 9.

The template selection unit 118 is not limited to the configuration of selecting a template from a plurality of candidates based on the priority.

For example, the template selection unit 118 may randomly select any one template from the candidates regardless of the priority.

<Processing in Case where Plurality of Candidate Blocks are Present to be Emphasized>

In a case where the image data is edited in accordance with the template, a plurality of candidate blocks to be emphasized may be present as in, for example, the case of presence of a plurality of keyword-included text blocks.

In this case, the image data editing unit 119 edits the image data so as to emphasize specific information in accordance with predetermined criteria.

For example, priority setting is performed in advance for each type of information included in the image data.

More specifically, the priority setting is performed with respect to the types of the blocks and the information included in the blocks.

In this case, the image data editing unit 119 edits the image data so as to preferentially emphasize what is high in priority.

For example, the map image, the photographic image, the keyword (conference), the keyword (holding), the keyword (advertisement), another keyword, and another image block are determined in descending order of priority.

Here, it is assumed that the text block including the keyword (conference), the text block including the keyword (holding), and the text block including the keyword (advertisement) are present in the image data.

In this case, for example, the template 12 is selected as the candidate template to be applied to the image data referring to the template application condition of the association information in FIG. 9.

The text block including the keyword (conference) has the highest priority among the three keyword-included text blocks.

In this regard, the image data editing unit 119 edits the image data so as to emphasize the text block including the keyword (conference) among the three text blocks.

More specifically, the text block including the keyword (conference) is disposed in the region 12B (see FIG. 5B) and the other two text blocks are disposed in the region 12A (see FIG. 5B).

The image data editing unit 119 is not limited to the configuration of emphasizing specific information based on the priority.

For example, the image data editing unit 119 may randomly select a block from a plurality of candidates regardless of the priority and edit the image data so as to emphasize the selected block.

<Specific Example of Image Data Editing Processing>

Next, a specific example of image data editing processing will be described.

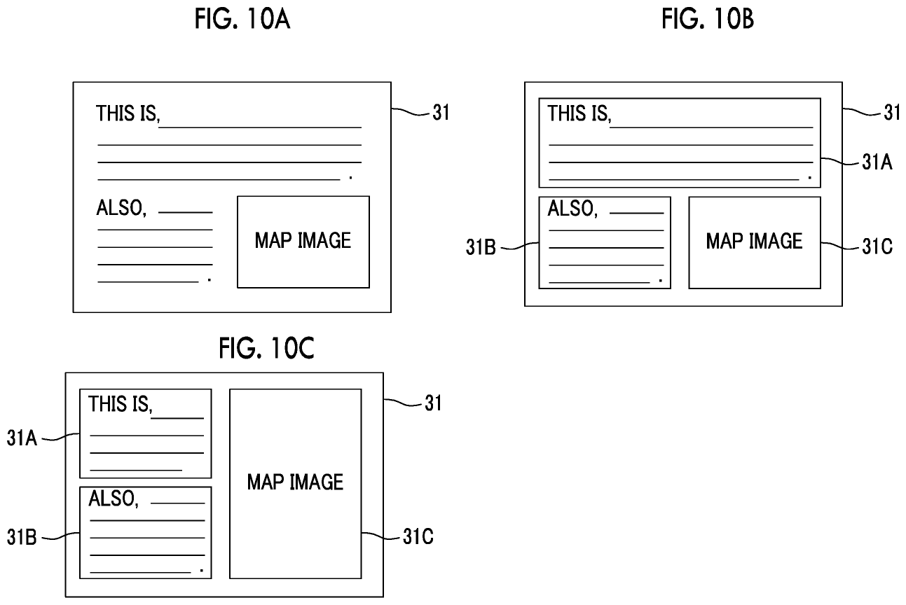

FIGS. 10 to 12 are diagrams illustrating the specific example of the image data editing processing.

The following steps (symbol “S”) respectively correspond to the steps in FIG. 4.

First, the image data acquisition unit 111 acquires image data 31 illustrated in FIG. 10A as image data to be displayed on the display device 200 (S101).

Next, the block extraction unit 112 extracts a block in the image data 31 (S102).

Three blocks are extracted in this example.

Then, the block classification unit 113 performs classification with regard to each block (S103).

In this example, the classification is performed into a text block 31A, a text block 31B, and a map image 31C as illustrated in FIG. 10B.

Next, the text information extraction unit 114 extracts text information with regard to the text block 31A and the text block 31B (S104).

In addition, the keyword search unit 115 searches for keywords with regard to the text block 31A and the text block 31B (S105).

In this example, no keyword is included in the text information of the text block 31A and the text block 31B.

Next, the display device information acquisition unit 116 acquires information on the display device 200 displaying the image data 31 (S106).

Acquired as the information on the display device 200 in this example are the screen size being 40 inches (screen size being “standard” in this example) and the screen shape being horizontal.

Next, the template selection unit 118 selects a template to be applied to the image data 31 (S107).

Here, the template selection unit 118 selects the template based on, for example, one map image being present in the image data 31 and the screen size of the display device 200 being “standard” and the screen shape being horizontal.

Referring to the association information illustrated in FIG. 9, the template 11 is selected since the template application condition of item number “1” is satisfied.

Next, the image data editing unit 119 edits the image data 31 in accordance with the template 11 (S108).

FIG. 10C is a diagram illustrating the edited image data 31.

The map image 31C is emphasized by the template 11 being applied.

Specifically, the map image 31C is enlarged in accordance with the region 11B (see FIG. 5A) determined by the template 11.

The text block 31A and the text block 31B are disposed in accordance with the region 11A (see FIG. 5A) determined by the template 11.

At that time, reduction or enlargement is performed.

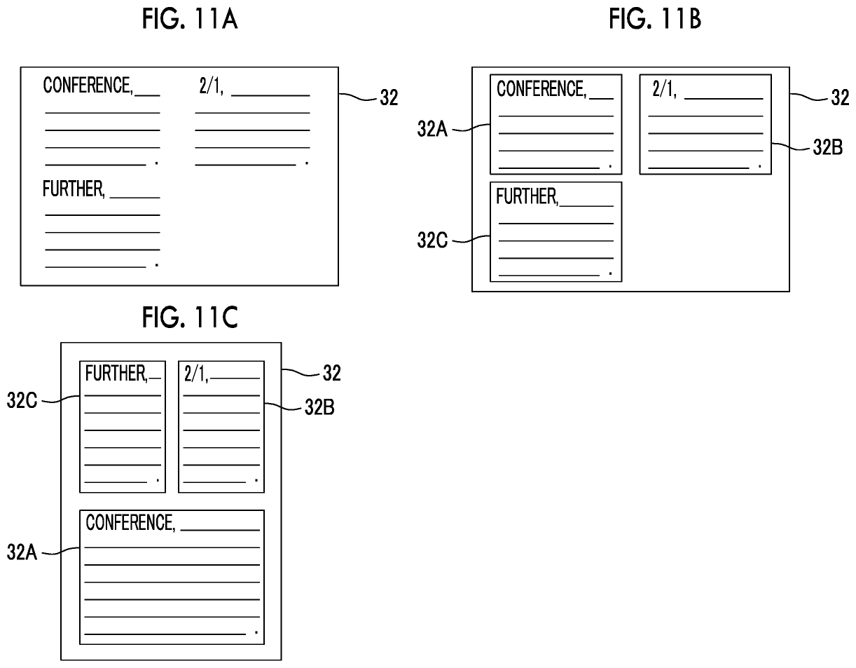

Next, image data 32 illustrated in FIG. 11A is image data to be displayed on the display device 200 and is processed similarly to the procedure in FIG. 10.

Here, in the image data 32, three blocks are extracted and classification is performed into text blocks 32A to 32C as illustrated in FIG. 11B.

In addition, text information is extracted by the text information extraction unit 114 and keyword searching is performed by the keyword search unit 115.

In this example, the text block 32A includes the keyword of “conference” and no keyword is included in the text block 32B and the text block 32C.

In addition, the display device information acquisition unit 116 acquires the screen size being 40 inches (screen size being “standard” in this example) and the screen shape being vertical as the information on the display device 200.

Next, the template selection unit 118 selects a template based on, for example, one keyword-included text block being present in the image data 32 and the screen size of the display device 200 being “standard” and the screen shape being vertical.

Referring to the association information illustrated in FIG. 9, the template 16 is selected since the template application condition of item number “7” is satisfied.

Next, the image data editing unit 119 edits the image data 32 in accordance with the template 16.

FIG. 11C is a diagram illustrating the edited image data 32.

By the template 16 being applied, the image data 32 is vertically edited so as to fit the vertical screen.

In addition, the text block 32A is emphasized.

Specifically, the text block 32A is enlarged in accordance with the region 16B (see FIG. 7B) determined by the template 16.

The text block 32B and the text block 32C are disposed in accordance with the region 16A (see FIG. 7B) determined by the template 16.

At that time, reduction or enlargement is performed.

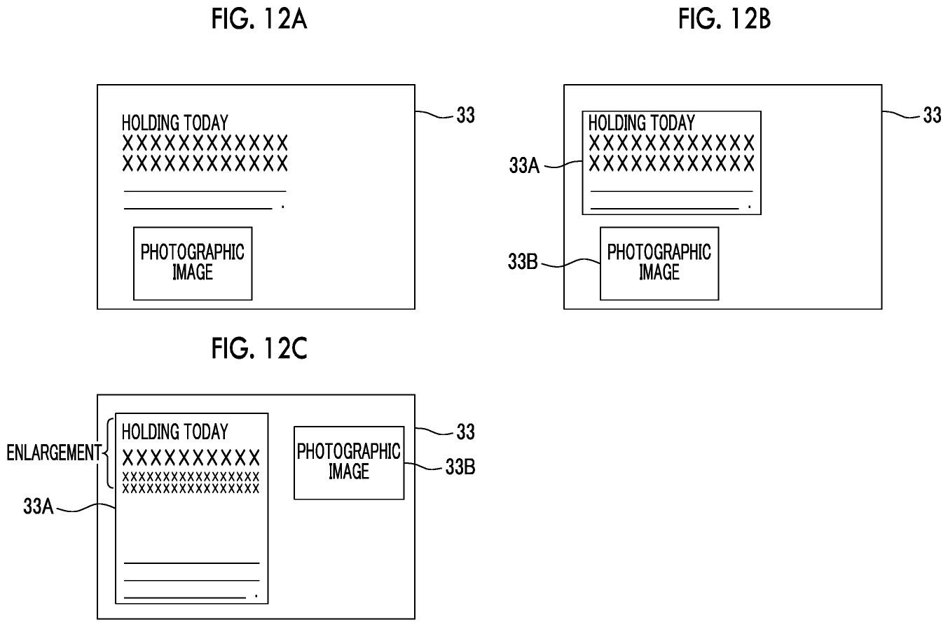

Next, image data 33 illustrated in FIG. 12A is image data to be displayed on the display device 200 and is processed similarly to the procedure in FIG. 10.

In the image data 33, two blocks are extracted and classification is performed into a text block 33A and a photographic image 33B as illustrated in FIG. 12B.

In addition, text information is extracted by the text information extraction unit 114 and keyword searching is performed by the keyword search unit 115.

In this example, the text block 33A includes the keyword of “holding”.

In addition, the display device information acquisition unit 116 acquires the screen size being 5 inches (screen size being “small” in this example) and the screen shape being horizontal as the information on the display device 200.

Next, the template selection unit 118 selects a template to be applied to the image data 33.

Here, the template selection unit 118 selects the template based on, for example, one photographic image and one text block being present in the image data 33 and the screen size of the display device 200 being “small” and the screen shape being horizontal.

Referring to the association information illustrated in FIG. 9, the template 21 is selected since the template application condition of item number “12” is satisfied.

Next, the image data editing unit 119 edits the image data 33 in accordance with the template 21.

FIG. 12C is a diagram illustrating the edited image data 33.

The text block 33A is emphasized by the template 21 being applied.

Specifically, the text block 33A is enlarged in accordance with the region 21A (see FIG. 8C) determined by the template 21.

At that time, of the texts in the text block 33A, the text in the region around the keyword “holding” is enlarged and the other texts are not enlarged.

The photographic image 33B is disposed in accordance with the region 21B (see FIG. 8C) determined by the template 21.

At that time, reduction or enlargement is performed.

In this manner, in the present exemplary embodiment, the image data editing unit 119 applies a template to image data and edits the image data so as to emphasize specific information in the image data.

The template selection unit 118 uses information on the display device 200 during template selection. Accordingly, the image data is edited such that, for example, display is performed in view of the screen of the display device 200.

Here, in a case where the image data is displayed by a plurality of the display devices 200, the image data is edited for each display device 200 such that the display is performed in view of the respective screens of the display devices 200.

### Modification Example

Next, a modification example of the present exemplary embodiment will be described.

(Example of Displaying Image Data Before Display on Display Device)

In the present exemplary embodiment, the image data edited by the display control device 100 may be displayed on a display unit other than the display device 200 such as the display unit (not illustrated) of the image processing device 300 and the display mechanism 106 of the display control device 100 before the image data is displayed on the display device 200.

An image data editing operation may be received in a case where the image data is displayed on the display unit other than the display device 200.

In a case where the image data is displayed on the display unit of the image processing device 300, for example, the image processing device 300 receives the image data editing operation from an operator.

The image data editing operation is, for example, an operation for enlarging the information included in the image data or an operation for changing the position of the information included in the image data.

More specifically, the image data editing operation is, for example, to designate a block in the image data and enlarge or change the position of the designated block.

The image processing device 300 may receive an operation for changing the template to be applied to the image data.

For example, the image processing device 300 displays a list of templates in a case where the image processing device 300 displays the image data edited by the display control device 100.

Then, once a template is selected by an operator, the image processing device 300 applies the template selected by the operator to the image data.

Here, the template is applied to the image data yet to be edited by the display control device 100.

Then, the image processing device 300 displays the image data edited by the template being applied on the display unit.

Further, the image processing device 300 may continue to receive another template selection.

The image processing device 300 displays the edited image data on the display unit with the selected template applied each time the template is selected.

The image processing device 300 may receive a template selection operation and another operation for image data editing (such as an operation for enlarging the information included in the image data and an operation for changing the position of the information included in the image data).

Although the image processing device 300 receives the image data editing operation in this example, the image data editing operation may be received by the display control device 100 or the like instead.

(Example of Displaying Pre-editing Image Data) In the present exemplary embodiment, not only edited image data but also pre-editing image data may be displayed on the display device 200.

For example, once the display control device 100 edits image data, information included in the image data may be deleted or reduced while specific information in the image data is emphasized.

The pre-editing image data is displayed in addition to the edited image data in this regard.

In this case, the display control device 100 transmits the pre-editing image data to the display device 200 in addition to the edited image data.

Then, the display device 200 displays the pre-editing image data and the edited image data.

For example, the display device 200 displays the pre-editing image data and the edited image data in order.

More specifically, for example, the display device 200 displays the pre-editing image data after displaying the edited image data.

In another example, the display device 200 may alternately display the pre-editing image data and the edited image data by switching at regular intervals.

In yet another example, the display device 200 may simultaneously display the pre-editing image data and the edited image data on the display unit.

(Example of Image Data Printing) In the present exemplary embodiment, the image processing device 300 may print the edited image data.

In this case, for example, the display control device 100 outputs the edited image data to the image processing device 300 and instructs the data to be printed once the image data is edited.

The image processing device 300 prints the edited image data in accordance with the printing instruction.

Here, the display control device 100 may instruct the pre-editing image data to be printed.

Then, the image processing device 300 may print the pre-editing image data in addition to the edited image data in accordance with the printing instruction.

At that time, the image processing device 300 may print the pre-editing image data and the edited image data on different sheets or the same sheet.

### Another Modification Example

In the present exemplary embodiment, the content of the character string of the template may vary with the place of installation of the display device 200 in the case of preparation of the template defining the text block including the specific character string such as conference, holding, and guide.

In a case where the display device 200 is installed at a retail store, for example, “holding” and “sale” are the keywords of the template 12 illustrated in FIG. 5B.

Then, the template 12 is applied in a case where the image data has one text block including the keyword of “holding” or “sale”.

In a case where the display device 200 is installed at an office, “conference” is the keyword of the template 12.

Then, the template 12 is applied in a case where the image data has one text block including the keyword of “conference”.

Although only the keyword-included text block is defined as the text block of the template in the example described above, the present invention is not limited to the configuration.

For example, a template defining a text block including a character string with a specific color (such as red), a text block including an underlined character string, and the like may be prepared and the text blocks may be emphasized.

In this case, for example, the text information extraction unit 114 collects the features of the text information as well in extracting the text information.

Then, the template selection unit 118 selects a template in view of the collected features of the text information.

Here, the text block including the character string with the specific color and the text block including the underlined character string is used as an example of text information satisfying a specific condition.

In the example illustrated in FIG. 9, conditions corresponding to the type of the block, the keyword in the text block, the information on the display device 200, and the like are determined with the items of “screen shape”, “screen size”, and “block content” provided as the template application conditions. However, the present invention is not limited to the configuration.

For example, the items of “screen shape” and “screen size” may not be provided as the template application conditions.

In other words, the template application condition may be a condition determined with regard to the information included in the image data alone.

In other words, in a case where the information included in the image data satisfies the template application condition, the template selection unit 118 may select the template corresponding to the template application condition without considering the information on the display device 200.

In another example, the template application condition may be a condition determined with regard to the type of the block alone or a condition determined with regard to the keyword in the text block alone.

In yet another example, the template application condition may be a condition determined with regard to the information on the display device 200 alone with the item of “block content” not provided.

Also conceivable in the present exemplary embodiment is the specific information being reduced once the template is applied in a case where the specific information has a certain size or more.

In this case, the template may be applied or the template may not be applied (that is, the image data may not be edited).

In the present exemplary embodiment, the display device 200 or the image processing device 300 may partially or fully execute the processing executed by the display control device 100.

For example, the image processing device 300 may execute the processing of the block extraction unit 112, the block classification unit 113, the text information extraction unit 114, the keyword search unit 115, the display device information acquisition unit 116, the template selection unit 118, and the like.

In the present exemplary embodiment, the image data may be displayed on the display unit of the image processing device 300, the display mechanism 106 of the display control device 100, or the like instead of the display device 200.

The program realizing the exemplary embodiment of the present invention can be provided by being stored in a storage medium such as a CD-ROM as well as by communication means.

Although various exemplary embodiments and modification examples have been described above, it is a matter of course that the exemplary embodiments and modification examples may be combined.

In addition, the present disclosure is not limited to the above exemplary embodiment and can be implemented in various forms without departing from the scope of the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
an acquisition section that acquires image data; and
an editing section that, in a case where a form determined to emphasize specific information in image data is prepared in advance and information included in the acquired image data satisfies a predetermined condition, edits the image data so as to emphasize the specific information in the image data in accordance with the form.

2. The information processing system according to claim 1,
wherein the predetermined condition is a condition determined based on whether or not at least one of text information satisfying a specific condition or image information satisfying a specific condition is present as the specific information.

3. The information processing system according to claim 2,
wherein the predetermined condition is a condition that text information including a specific character string is present as the text information satisfying the specific condition and
the editing section emphasizes the specific character string in the image data in a case where the information included in the image data satisfies the predetermined condition.

4. The information processing system according to claim 2,
wherein the predetermined condition is a condition that a specific type of image information is present as the image information satisfying the specific condition and
the editing section emphasizes the specific type of image information in the image data in a case where the information included in the image data satisfies the predetermined condition.

5. The information processing system according to claim 1,
wherein a plurality of the predetermined conditions are present, the form is prepared for each of the predetermined conditions, and
the editing section edits the image data in accordance with the form corresponding to one of the plurality of predetermined conditions by a predetermined criterion in a case where the information included in the image data satisfies the plurality of predetermined conditions.

6. The information processing system according to claim 5,
wherein priorities are respectively set in a plurality of the forms, and
the editing section edits the image data in accordance with the form highest in priority among the forms respectively corresponding to the plurality of predetermined conditions in a case where the information included in the image data satisfies the plurality of predetermined conditions.

7. The information processing system according to claim 5,
wherein a priority is set for each type of information included in image data, and
the editing section edits the image data in accordance with the form determined to emphasize the information highest in priority in a case where the information included in the image data satisfies the plurality of predetermined conditions.

8. The information processing system according to claim 6,
wherein the priority is determined in accordance with a place where a display section that displays the image data after editing by the editing section is present.

9. The information processing system according to claim 7,
wherein the priority is determined in accordance with a place where a display section that displays the image data after editing by the editing section is present.

10. The information processing system according to claim 1,
wherein the editing section emphasizes the specific information in accordance with the form and deletes other information in the image data in a case where the information included in the image data satisfies the predetermined condition.

11. The information processing system according to claim 1,
wherein the predetermined condition is determined with regard to information included in the image data and determined with regard to the information on a display section that displays the image data after editing by the editing section, and
the editing section edits the image data in accordance with the form in a case where the information included in the image data and the information on the display section satisfy the predetermined condition.

12. The information processing system according to claim 11,
wherein the information on the display section is information indicating a size of a screen of the display section.

13. The information processing system according to claim 11,
wherein the information on the display section is information indicating a shape of a screen of the display section.

14. The information processing system according to claim 1, further comprising a display section that displays the image data after editing and the image data before editing.

15. The information processing system according to claim 14,
wherein the display section displays the image data after editing and the image data before editing in order.

16. A non-transitory computer readable medium storing a program causing a computer to realize a function of acquiring image data and a function of, in a case where a form determined to emphasize specific information in image data is prepared in advance and information included in the acquired image data satisfies a predetermined condition, editing the image data so as to emphasize the specific information in the image data in accordance with the form.

17. An information processing system comprising:
acquisition means for acquiring image data; and
editing means, in a case where a form determined to emphasize specific information in image data is prepared in advance and information included in the acquired image data satisfies a predetermined condition, for editing the image data so as to emphasize the specific information in the image data in accordance with the form.
